(19) United States
(12) Patent Application Publication
(10) Pub. No.: US 2019/0373150 A1
(43) Pub. Date: Dec. 5, 2019

(54) IMAGING MODULE

(71) Applicants: TRIPLE WIN TECHNOLOGY(SHENZHEN) CO.LTD., Shenzhen (CN); HON HAI PRECISION INDUSTRY CO., LTD., New Taipei (TW)

(72) Inventors: SHIN-WEN CHEN, New Taipei (TW); JING-WEI LI, Shenzhen (CN); SHENG-JIE DING, Shenzhen (CN); JIAN-CHAO SONG, Shenzhen (CN)

(21) Appl. No.: 16/018,168

(22) Filed: Jun. 26, 2018

(30) Foreign Application Priority Data
Jun. 5, 2018 (CN) 201810571361.X

(51) Int. Cl. H04N 5/225; G03B 17/55

(52) U.S. Cl. CPC H04N 5/2257; H04N 5/2251; G03B 17/55

(57) ABSTRACT

An imaging module allows heated internal gas to escape out of a camera/imaging module when heat is applied to the module during an adhesive curing manufacturing step without making manufacture more difficult due to molding issues. The imaging module includes a lens holder with top and bottom surfaces. The bottom surface defines an opening at a bottom of the lens holder. The opening extends through the inside and outside walls of the lens holder. The opening allows heated internal gas to escape out of a camera/imaging module.

### FIELD

The subject matter relates to imaging modules.

### BACKGROUND

An imaging module (such as a camera module and a projection module) generally includes a circuit board, a lens holder, and a lens barrel. During assembly, the lens holder is fixed on the substrate. The lens barrel is accommodated and fixed in the lens holder. The lens barrel and the lens holder are generally fixed together by adhesive. After assembly, the imaging module needs to be heated to solidify the adhesive to ensure the fixing stability. Therefore, gas escape holes are designed in the lens holder to allow the release of the increased pressure of internal gases caused by heating, to prevent the imaging module from damage. However, the gas escape holes increase the difficulty of mold design, make the imaging module to be difficult to separate from the mold after molding, and affect the structural strength of the imaging module. Additionally, the gas escape holes need to be sealed after the heating process, which adds an additional production process.

Accordingly, there is room for improvement within the art.

### BRIEF DESCRIPTION OF THE DRAWINGS

Implementations of the present technology will now be described, by way of example only, with reference to the attached figures, wherein:

FIG. 1 is a diagram of a first embodiment of a camera module.

FIG. 2 is an exploded diagram of the camera module of FIG. 1.

FIG. 3 is a diagram of a second embodiment of a camera module.

FIG. 4 is an exploded diagram of the camera module of FIG. 3.

FIG. 5 is a diagram of a third embodiment of a projection module.

FIG. 6 is an exploded diagram of the projection module of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

One definition that applies throughout this disclosure will now be presented.

The term “substantially” is defined to be essentially conforming to the particular dimension, shape, or other feature that the term modifies, such that the component need not be exact. For example, “substantially rectangular” means that the object resembles a rectangle, but can have one or more deviations from a true rectangle.

The term “comprising,” when utilized, means “including, but not necessarily limited to”; it specifically indicates open-ended inclusion or membership in the so-described combination, assembly, series, and the like.

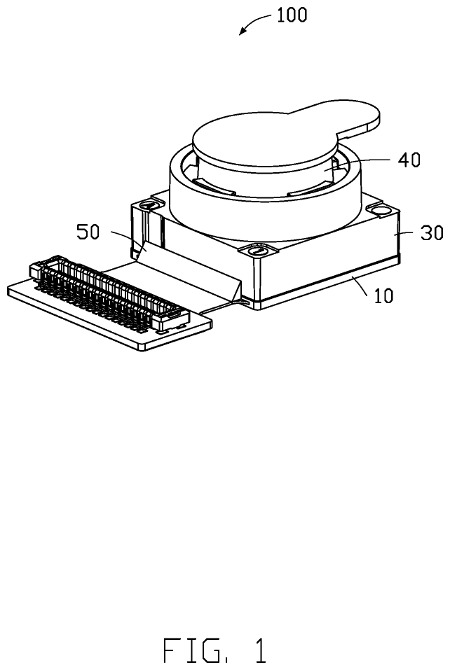

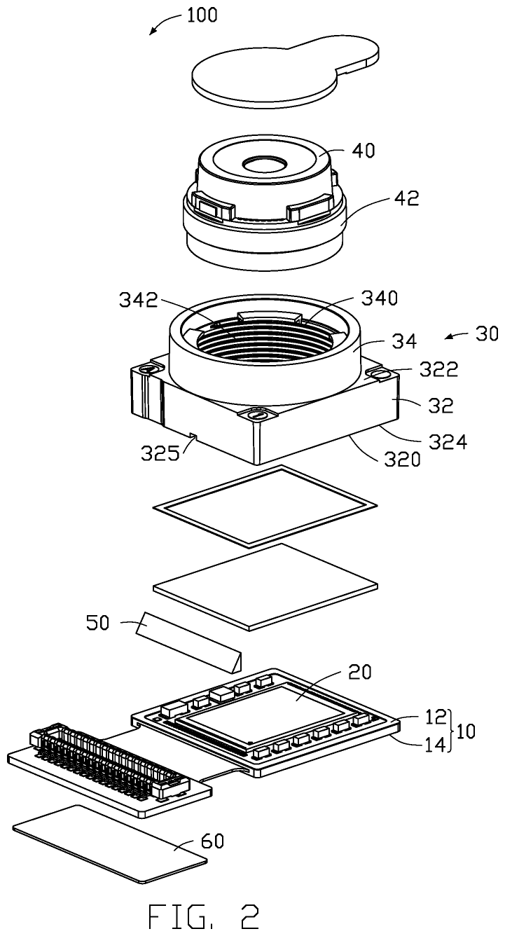

FIGS. 1-2 illustrate a first embodiment of a camera module 100. The camera module 100 includes a fixed-focus camera module. The camera module 100 comprises a circuit board 10, an image sensor 20, a lens holder 30, and a lens barrel 40. The image sensor 20 and lens holder 30 are fixed to the circuit board 10 by adhesive.

The circuit board 10 comprises a first surface 12 and a second surface 14. The first surface 12 and the second surface 14 are opposite to each other. In the embodiment, the circuit board 10 is a flexible circuit board. The first surface 12 is parallel to the second surface 14.

The image sensor 20 is positioned on the first surface 12, and is electrically connected to the circuit board 10.

The lens holder 30 is fixed on the first surface 12. In the embodiment, the lens holder 40 is made of plastic. The lens holder 30 is integrally formed. The image sensor 20 is received in the lens holder 30. The lens holder 40 comprises a base 32 and a receiving portion 34. The receiving portion 34 is connected to the base 32.

The base 32 is substantially rectangular. The base 32 comprises a top surface 322 and a bottom surface 324. The top surface 322 and the bottom surface 324 are opposite to each other. In the embodiment, the top surface 322 is parallel to the bottom surface 324. A first groove 420 is defined in the base 32. The first groove 420 extends through the top surface 322 and the bottom surface 324. The first groove 320 is rectangular. The first groove 320 receives the image sensor 20. An opening 325 is defined in the bottom surface 324. The opening 325 allows internal gas to escape when heat is applied to the camera module 100, thereby preventing damage to the camera module 100 resulting from the expansion of the internal gas. The opening 325 extends through the inner and outer sides of the side wall of the lens holder 30. In the embodiment, the opening 325 is rectangular.

The receiving portion 34 is substantially cylindrical. A second groove 340 is defined in the housing portion 34. The receiving portion 34 receives the lens barrel 40. The second groove 340 extends through the housing portion 34. The second groove 340 is cylindrical. The second groove 340 connects to the first groove 320. A plurality of internal threads 342 is formed on the inner wall of the receiving portion 34.

The lens barrel 40 is made of metal. The lens barrel 40 is received in the second groove 340. A plurality of external threads 42 is formed on the outer wall of the lens barrel 40. The external threads 42 match the internal threads 342, thereby the lens barrel 40 is fixed in the second groove 340.

During assembly, the lens holder 30 is fixed to the circuit board 10. The image sensor 20 is fixed and electrically connected to the circuit board 10. Then, the lens barrel 40 is positioned in the second groove 340, and a position of the lens barrel 40 can be adjusted to align the central axis of the lens barrel 40 with a center of an imaging area of the image sensor 20.

After assembly, the camera module 100 is placed in a heating device (not shown) for heat curing of the adhesive the adhesive. Because the opening 325 is defined in the lens holder 30, heated gas inside the camera module 100 can escape out during the heating, thereby preventing damage to the camera module 100 caused by expansion of internal gas.

After the heating, an adhesive layer 50 is formed between the circuit board 10 and the outer wall of the lens holder 30. The adhesive layer 50 fills the gap between the circuit board 10 and lens holder 30, sealing opening 325.

The camera module 100 further comprises a reinforcing plate 60. The reinforcing plate 60 is glued to the second surface 14 of the circuit board 10 for enhancing the structural strength of the circuit board 10. The adhesive for gluing the reinforcing plate 60 is the same as the adhesive of the adhesive layer 50. Thus, the adhesive layer 50 can be formed together with the gluing of the reinforcing plate 60. That is, the single extra step of sealing the opening 325 can be avoided. In the embodiment, the adhesive for gluing the reinforcing plate 60 is an ultraviolet-curable adhesive.

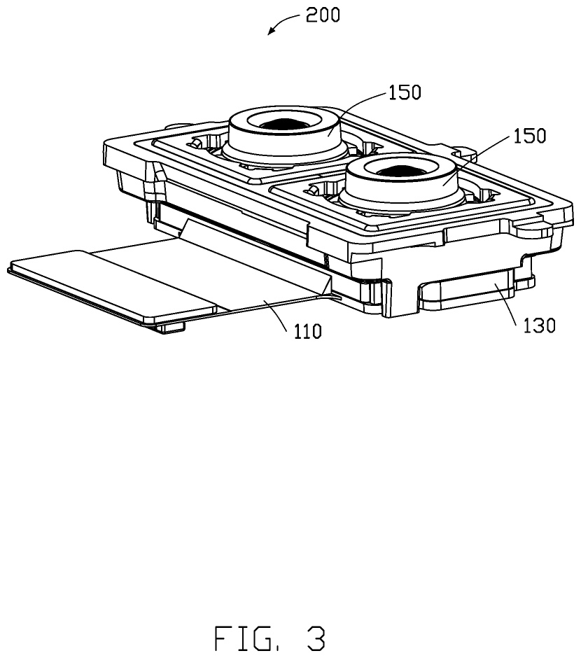

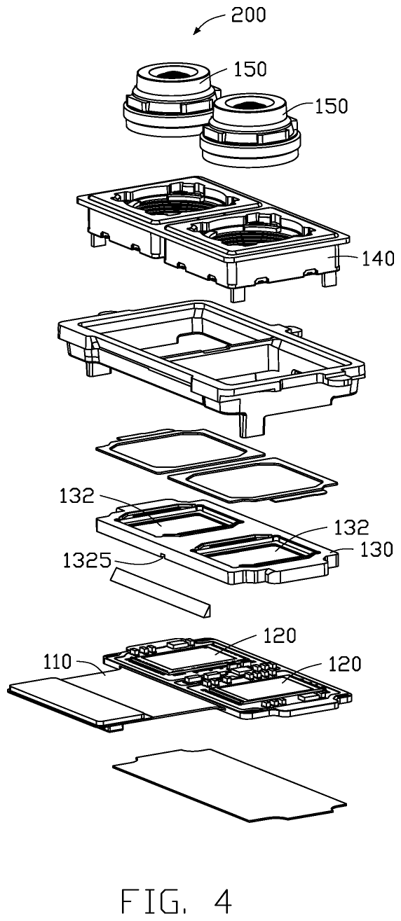

Referring to FIG. 3 and FIG. 4, a camera module 200 of a second embodiment is provided. The difference from the camera module 100 is that the camera module 200 is a dual-lens and auto-focus camera module. The camera module 200 comprises a circuit board 110, two image sensors 120, a lens holder 130, a voice coil motor 140, and two lens barrels 150. The lens holder 130 defines two grooves 132 for receiving the two image sensors 120. Each groove 132 corresponds to one lens barrel 150 and one image sensor 120. The two grooves 132 are spaced from each other. The opening 1325 is located at the bottom of the lens holder 130 close to the circuit board 110, and between the two grooves 132. The opening 1325 penetrates the inner and outer sides of the side wall of the lens holder 130. The voice coil motor 140 is configured to drive the two lens barrels 150 to move within the camera module 200. In the embodiment, each voice coil motor 140 defines a receiving groove (not shown). Each lens barrels 150 is accommodated in one receiving groove of the voice coil motor 140.

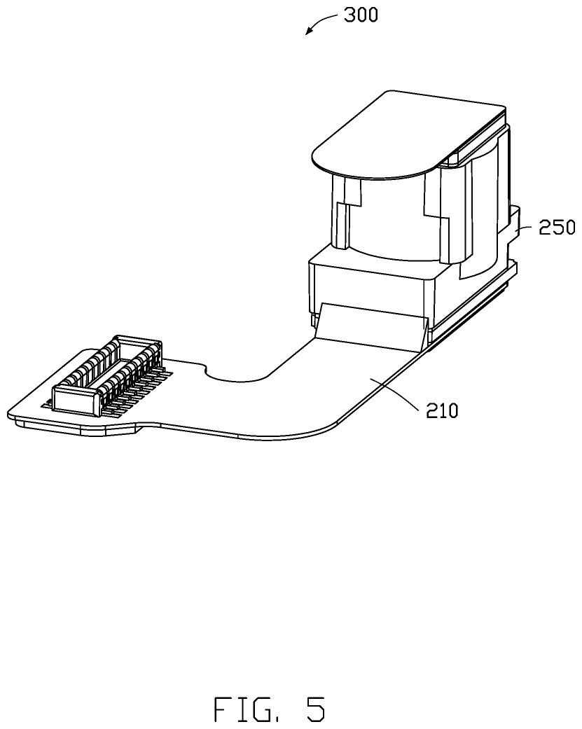

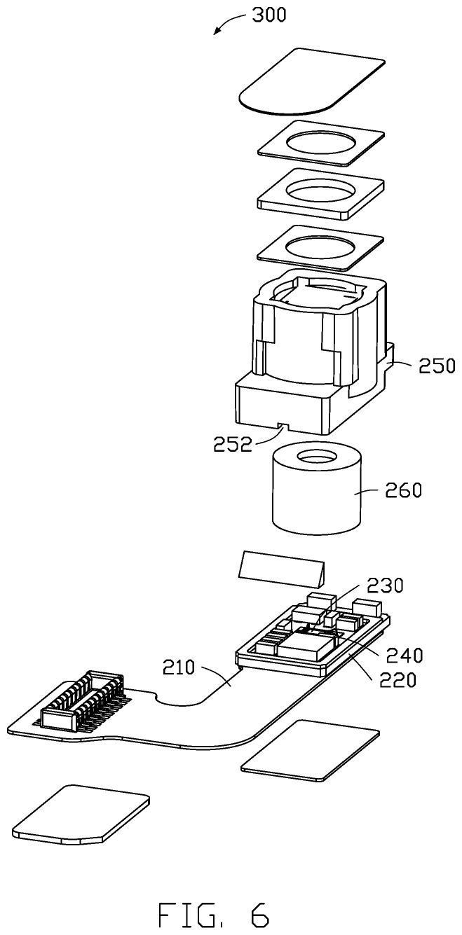

Referring to FIG. 5 and FIG. 6, a projection module 300 of a third embodiment is provided. The projection module 300 is used in a stereoscopic projector. The projection module 300 comprises a circuit board 210, a ceramic substrate 220, a laser emitter 230, an electronic component 240, a lens holder 250, and a lens barrel 260. The ceramic substrate is fixed on the circuit board 210. The laser emitter 230 and the electronic component 240 are fixed on the ceramic substrate 220. The lens holder 250 is positioned on the circuit board 210 and covers the ceramic substrate 220. The lens barrel 260 is accommodated in the lens holder 250. The projection module 300 functions by emitting laser light and receiving reflected laser light. An opening 252 is defined in the lens holder 250. The opening 252 is located at the bottom of the circuit board 210. The opening 252 penetrates the inner and outer sides of the side wall of the lens holder 250. The shape, size, position, and functions of the opening 252 are the same as those of the opening 325.

In the imaging modules (such as the camera modules 100, 200 and the projection module 300), the openings 325, 1325, and 252 are formed at the bottom of the lens holder 30, 130, and 250, and are close to the circuit board 10, 110, and 210. The openings 325, 1325, and 252 penetrate the inner and outer sides of the lens holders 30, 130, and 250. Because the openings 325, 1325, and 252 are positioned at the bottoms of the lens holders 30, 130, and 250, the manufacturing difficulty of the molding dies for molding the holders 30, 130, and 250 is reduced. After molding, the lens holders 30, 130, and 250 are more easily removable from their molds. Additionally, the openings 325, 1325, and 252 can be sealed together when the image module is glued to the reinforcing plate 60. Thus, a single extra step for sealing the openings is avoided, thereby reducing the manufacturing cost.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A camera module comprising:
a lens holder comprising a top surface and a bottom surface opposite to the top surface, the bottom surface positioned at a bottom of the lens holder;
wherein an opening is defined in the bottom surface, the opening extends through an inside wall and an outside wall of the lens holder, the opening allows heated internal gas to escape out of the camera module.

2. The camera module of claim 1, wherein the opening is rectangular.

3. The camera module of claim 1, further comprising a circuit board, wherein the bottom surface is fixed on the circuit board.

4. The camera module of claim 3, further comprising an adhesive layer, wherein the adhesive layer is formed between the circuit board and the outer wall of the lens holder, during curing of the adhesive, melted adhesive forms between the circuit board and the lens holder, and the adhesive, when hardened, seals the opening.

5. The camera module of claim 4, wherein the circuit board is a flexible circuit board, the camera module further comprises a reinforcing plate, the reinforcing plate is glued to the circuit board by adhesive, and is opposite to the lens holder, the adhesive layer is formed when the reinforcing plate is glued to the circuit board.

6. The camera module of claim 1, further comprising at least a lens holder, wherein at least one groove is defined in the top surface, the groove extends through the top surface and the bottom surface, the lens holder is received in the groove.

7. The camera module of claim 6, wherein the camera module is selected from one of a fixed-focus camera module, an auto-focus camera module, and a dual-lens camera module.

8. The camera module of claim 7, wherein when the camera module is a dual-lens camera module, the lens holder defines two grooves, each groove corresponds to one lens barrel and one image sensor, the two grooves are spaced from each other, and the opening is located at the bottom of the lens holder close to the circuit board, and is located between the two grooves.

9. The camera module of claim 3, further comprising an image sensor, wherein the image sensor is fixed on the circuit board, and the circuit board is received in the opening.

10. The camera module of claim 1, wherein the lens holder is rectangular and is integrally formed.

11. A projection module comprising:
a lens holder comprising a top surface and a bottom surface opposite to the top surface, the bottom surface positioned at a bottom of the lens holder, wherein an opening is defined in the bottom surface, the opening extends through an inside wall and an outside wall of the lens holder, the opening allows heated internal gas to escape out of the camera module.

12. The projection module of claim 11, wherein the opening is rectangular.

13. The projection module of claim 11, further comprising a circuit board, wherein the bottom surface is fixed on the circuit board.

14. The projection module of claim 13, further comprising an adhesive layer, wherein the adhesive layer is formed between the circuit board and the outer wall of the lens holder, during curing of the adhesive, melted adhesive forms between the circuit board and the lens holder, and the adhesive, when hardened, seals the opening.

15. The projection module of claim 14, wherein the circuit board is a flexible circuit board, the projection module further comprises a reinforcing plate, the reinforcing plate is glued to the circuit board by adhesive, and is opposite to the lens holder, the adhesive layer is formed when the reinforcing plate is glued to the circuit board.

16. The projection module of claim 11, further comprising at least a lens holder, wherein at least one groove is defined in the top surface, the groove extends through the top surface and the bottom surface, the lens holder is received in the groove.

17. The projection module of claim 13, wherein the projection module comprises a ceramic substrate, a laser emitter, and an electronic component, the ceramic substrate is fixed on the circuit board, the laser emitter and the electronic component are fixed on the ceramic substrate.

18. The projection module of claim 17, wherein the lens holder is positioned on the circuit board and covers the ceramic substrate.

19. The projection module of claim 11, wherein the lens holder is rectangular and is integrally formed.
